(19) United States
(12) Patent Application Publication
(10) Pub. No.: US 2011/0128897 A1
(43) Pub. Date: Jun. 2, 2011

(54) DEVICE AND METHOD FOR SWITCHING AND/OR CONTROLLING A NUMBER OF FUNCTIONS

(76) Inventor: Peter Neumann, Munich (DE)

(21) Appl. No.: 12/933,853

(22) PCT Filed: Mar. 24, 2009
(86) PCT No.: PCT/EP2009/002139

§ 371 Date: Dec. 2, 2010

(30) Foreign Application Priority Data
Jun. 9, 2008 (DE) 10 2008 027 377.5

(51) Int. Cl. H04W 4/00

(52) U.S. Cl. 370/310

(57) ABSTRACT

The invention relates to a device and method for switching and/or controlling a number of functions by switching electrical supply lines and/or by means of remote control signals, wherein input commands are addressed and received using network addresses, the received input commands are converted into corresponding output commands for switching and/or controlling and the generated output commands are used for switching and/or controlling the functions.

The invention relates to a method of and an apparatus for switching and/or controlling a number of functions by switching electrical supply lines and/or by remote-control signals.

Such methods and apparatuses are known. In particular, sockets based on GSM receiver modules, i.e. mobile wireless network receiver modules, have been known for some time by means of which electrical devices may be accessed via the GSM receiver modules, i.e. via a mobile wireless network, and may thus be switched on or off by switching commands transmitted via the mobile wireless network.

It is disadvantageous that each receiver must always have a SIM card by subscription, and the corresponding monthly costs increase linearly with the number of devices. In addition, this approach always allows only one switching operation per device.

A further disadvantage is that adequate wireless reception must always be provided so that an error-free switching function may be performed, since this function is carried out via the mobile wireless network.

The object of the invention is to overcome the above-given disadvantages and to provide a method of and an apparatus for switching and/or controlling a number of functions, without at the same requiring a number of receivers as well as SIM cards for operating the receivers in a cellular mobile wireless network or the like. In particular, the aim of the invention is to reduce the corresponding complexity of installation.

This object is attained according to the invention using a method according to claim 1 and an apparatus according to claim 8. Advantageous refinements of the method according to the invention and of the apparatus according to the invention are given in the respective dependent claims.

In the method according to the invention for switching and/or controlling a number of functions by switching electrical supply lines and/or by remote-control signals, it is particularly advantageous that input commands are addressed and received via a network, using a network address, the received input commands being converted to corresponding output commands, and the generated output commands are sent for switching and/or controlling the is functions.

A number of functions may thus be activated, since the corresponding switching commands are received as input commands via a network, and are then converted to corresponding output commands that are then sent, i.e. transmitted, to the appropriate switching equipment and/or devices.

The received input commands are preferably formed by a base address and a subaddress, the base address corresponding to the network address and the subaddress referring to a specific switching command and/or a device to be switched. The network address may be a call number and/or an IP address.

The network is preferably a telephone network and/or a computer network, and in particular may be a landline network or a mobile wireless network.

The switching and/or control may thus be carried out in a flexible manner, for example via a mobile wireless network as well as via a telephone landline network. In particular, unique addressing and transmission of the switching and control commands may be easily achieved.

The output command is preferably sent as a remote-control signal, using a signal transmitter. This remote-control signal in particular may be an infrared signal.

It is thus possible, for example, to convert any given received control signals in the form of input commands to corresponding remote-control signals such as infrared signals or the like, and to control any given device. For example, it is thus possible by transmitting an appropriate command that originates from a mobile wireless terminal, for example, to access a corresponding control device, using the mobile wireless network, by means of the appropriate call number and addition of the initiating command, as the result of which the corresponding infrared signal is then generated by the signal transmitter and sent, it being thus possible, for example, to control any given device via remote control using a mobile wireless terminal.

In this manner any given remote-controllable device, for example a video recorder or the like, may be controlled.

In one preferred embodiment, one or more electrical supply lines are switched on or off by the output commands. In particular, one or more electrical supply lines may be acted on by a predetermined or selectable voltage and/or current intensity, so that the function of a dimmer may also be achieved.

The receipt of the input commands and the signal conversion are preferably carried out by a base station of a local area network (LAN) that is connected to a number of network components and/or network users in the local network, in particular via cable connections and/or wireless connections.

In the apparatus according to the invention for switching and/or controlling a number of functions by switching electrical supply lines and/or by remote-control signals, it is particularly advantageous that the device may be addressed using a network address via a network, and commands may be received via this network, wherein the received commands may be converted to corresponding output commands by the apparatus, and/or the apparatus is set up to convert the received commands to corresponding output commands and to transmit or send the generated output commands for switching and/or controlling the functions, and that the apparatus is suited in particular for carrying out the method according to the invention.

The received commands are preferably formed by a base address and a subaddress, the base address corresponding to the network address and the subaddress referring to a specific switching command and/or a device to be switched. The network address may be a call number and/or an IP address.

The various components to be accessed may in particular be uniquely addressed and identified in this manner.

The network is preferably addressable by the apparatus via a network address, a telephone network, and/or a computer network, and in particular may be a landline network or a mobile wireless network, i.e. a telephone landline network or a mobile telephone network.

The apparatus preferably has a signal transmitter, the output command may be sent as a remote-control signal by the signal transmitter, and/or the signal transmitter is set up in such a way that the output command is sent in particular as an infrared signal, i.e. as a wireless remote-control signal, for controlling a wireless remote-controllable device.

The apparatus outputs commands that preferably switch on or off one or more electrical supply lines, in particular electrical supply lines being acted on by the apparatus with a predetermined voltage and/or current intensity, so that the function of a dimmer may also be achieved.

The apparatus may preferably be a base station of a local area network (LAN), and in particular the apparatus may have cable connections and/or wireless connections to a number of network components and/or network users in the local network.

Within a private local network the apparatus is preferably set up to communicate directly with network components and/or terminals, in particular via wireless connections.

That is, the apparatus preferably has an integrated personal area network (PAN for short, i.e. a private local network) functionality, so that the command may be transmitted directly via a mobile wireless network, landline network, computer network, or the like without establishing a connection. The communication may then take place, for example, via Bluetooth or another comparable communication standard. The communication between the apparatus and other network components and terminals such as mobile telephones or devices to be controlled may then take place directly within this personal local network, without having to use a public telephone network or computer network. Thus, in this case the communication takes place directly, not by using a mobile wireless network, landline network, computer network, or the like.

A private local network or personal area network (PAN) is understood to mean a network that may be set up and taken down on an ad hoc basis by small devices such as PDAs or mobile telephones. PANs may thus be set up using various wired transmission technologies, for example USB or FireWire, or also using wireless technologies, for example IrDA or Bluetooth (WPAN). The range is usually only a few meters, and therefore the PANs represent the smallest networks in the network hierarchy. PANs may be used for communication among the devices, but may also be used to communicate with a larger network (uplink). A PAN created using Bluetooth is also referred to as a “piconet.”

The method according to the invention is described in greater detail below with regard to the apparatus according to the invention. The prerequisite, for example, is a box located in the household that establishes a connection between a public network and a home network, for example via DSL and/or UMTS, or also via home gateways using NGMN, LTE, or other wireless technology.

This box may be uniquely reached either via a landline network using a landline network number, or via a mobile wireless network and thus using a wireless network number, and may be uniquely accessed via the telephone network. In addition, this box may, for example, provide an additional private network in a household, to which the various devices may be connected or linked.

This local or private network may either have technologies such as a LAN cable, power line communication (PLC), DECT, Bluetooth, or WLAN, or NGMN, LTE, or other wireless technologies. Further components of this local network include, in addition to appropriate network components, remote-controllable switches or power supply lines, power supply strips, and the like, to which any given devices not remotely controllable may be connected. Furthermore, devices may also be linked that convert a is received control signal to a series of infrared signals and emit same in order to appropriately remotely control remote-controllable devices by these infrared signals.

Thus, using the method according to the invention and the apparatus according to the invention it is advantageously possible, using a public telephone network such as the landline network and/or the mobile wireless network, to control a corresponding box and to transmit control commands via the telephone network, by means of which a number of functions may be externally activated within a local area by switching electrical supply lines and/or by remote-control signals.

Two embodiments of systems according to the invention are illustrated in the figures and explained below. In the figures:

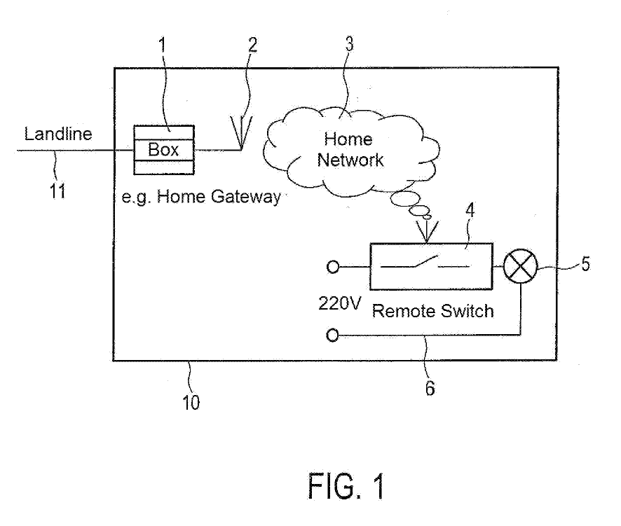

FIG. 1 shows a system for switching and/or controlling a number of functions that may be accessed via a telephone landline network connection; and

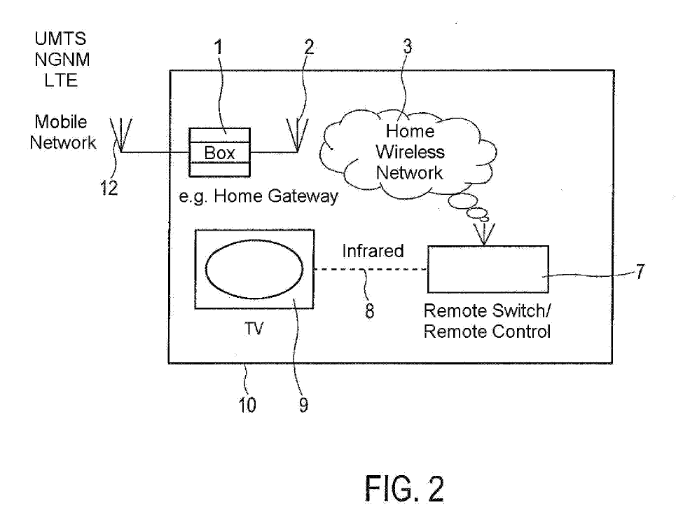

FIG. 2 shows a system for switching and/or controlling a number of functions that may be accessed via a mobile wireless network.

In the embodiments according to FIGS. 1 and 2, identical components are denoted by the same reference numerals in each case.

The systems according to FIGS. 1 and 2 each have a box 1 that establishes a connection between a public network and a home network. In the embodiment according to FIG. 1, the box 1 is equipped with a landline network connection 11, and therefore may be uniquely reached at a landline network number via a landline network.

In the embodiment according to FIG. 2, the receiver box 1 is equipped with a mobile wireless receiver system 12, i.e. in the embodiment according to FIG. 2 the box 1 may be uniquely reached at a mobile wireless number via a mobile wireless network such as a GSM network, a UMTS network, or via wireless technology such as NGMN or LTE.

The box 1 may thus be uniquely addressed using the landline network number (FIG. 1) or the mobile wireless number (FIG. 2). The linkage to the landline network via the landline network connection 11 may also be provided via DSL or the like.

The box 1, i.e. the home gateway, thus represents the interface with a house 10 or private residence or the like that is externally accessible and uniquely addressable via a telephone landline network or the internet (FIG. 1) or via a mobile wireless network (FIG. 2), via which the control commands for switching and/or controlling devices within the building 10 are transmitted.

The box 1 is additionally linked in the household to a private network 3 via an appropriate interface 2; i.e. the box 1 is integrated into a home wireless network 3 via the interface 2. A variety of devices and network components may be linked to this home wireless network 3. The embodiment illustrated in the figures involves wireless networks 3 within the local area. Alternatively or cumulatively, cable-based networks may also be connected to the box 1.

Via the local network 3, the same as for the embodiment according to FIG. 1, in particular switches 4 for electrical lines 6 are activated for controlling, i.e. switching on and off, corresponding terminals 5, as illustrated in FIG. 1.

In the example illustrated in FIG. 1, it is thus possible via the landline network connection 11 to uniquely address the box 1 using the landline network number, and to transmit a control command that is relayed via the interface 2 to the home network 3. Via the home network 3, the switch 4 is then actuated for switching the terminal 5 that is connected to the power supply line 6, on or off by respectively closing or opening the switch 4 in the supply line 6.

In the embodiment according to FIG. 2, the addressing of the receiver box 1 via the mobile wireless connection 12 is carried out using the mobile wireless number that serves to uniquely identify the box 1.

The box 1 is linked to the home network 3 via the interface 2. When an appropriate control signal is received via the mobile wireless network, the signal transmitter 7 that generates and sends an appropriate infrared signal 8 for remotely controlling the terminal 9 is actuated via the local network 3. In the example illustrated according to FIG. 2, the infrared signal 8 is used to control a TV set 9, i.e. for example the TV set 9 may be switched on, and/or a program selection may be made on the TV set 9, or a recorder integrated into the TV set 9 may be controlled, for example by initiating the start of a recording.

The network 3 according to the embodiments illustrated in FIGS. 1 and 2 may be linked to the network users of the network 3 via a LAN cable, power line communication (PLC), DECT, Bluetooth, WLAN, or other wireless technologies. In addition to the devices that are typically integrated into a network, such as a personal computer, printer, and the like, remote-controllable switches and/or power supply strips 4 are thus integrated that may be connected to any given non-remote-controllable devices 5. There is also a linkage to signal transmitters 7 that convert the received control signal into a series of infrared signals 8 and emit same, and that remotely control the corresponding devices 9 having an infrared input.

The subject matter of the system according to the invention as shown in FIGS. 1 and 2, therefore, is the receipt of control signals via a public telephone network, using the box 1, via an input, and the initiation of appropriate functions via an output. These functions may include switching supply voltages (of a socket, for example), as illustrated in FIG. 1, as well as sending remote-control signals, for example via infrared or Bluetooth, etc., the same as in the embodiment illustrated in FIG. 2.

The control signals are received by a central unit 1, a home gateway that is either connected via a landline network connection 11 such as DSL, for example, to a public network, or that allows receipt of signals of a mobile network via an appropriate interface 12. This central unit 1 may be placed at any given location, taking good or optimal reception capability into account, in order to make the received signals available by conversion to another technology, and by amplifying the power for as many rooms in the residence as possible. The reception may optionally be further improved by using repeaters.

The home gateway 1 is uniquely defined by a telephone number or IP address that at the same time represents the base address for the devices being controlled. The remote-controllable switches 4 or modules 7 and power supplies 6 have a freely selectable subaddress via which they may be uniquely accessed. To avoid confusion, it should also be possible for the switches 4, modules 7, and supply lines 6 to be assigned symbolic names that are converted to physical addresses by the home gateway 1. Thus, the complete address results from the base address and the subaddress.

The advantage is that in this case, any given number of sources 4, 6, 7 may be switched via a receiver unit 1, depending on the address space used. One embodiment could be as follows: A switching socket strip has a WLAN receiver with a connected microcontroller. The function of the microcontroller is to compare the address of commands that have just been received via WLAN to a preset address, and to initiate a switching signal, for example on/off, when the addresses match.

In another embodiment a WLAN module receives a control signal that is detected by a microcontroller and is converted to a remote-control signal, and as a result infrared modulation is transmitted for controlling a DVD recorder, for example.

Thus, any given functions and devices may be activated, even the initiation of remote support in building installations by accessing house and building technology.

1. A method for switching and/or controlling a number of functions by switching electrical supply lines or by remote-control signals, wherein
input commands are addressed and received using a network address,
the received input commands are converted to corresponding output commands for switching or control, and
the generated output commands are sent for switching or controlling the functions.

2. The method according to claim 1, wherein
the received input commands are formed by a base address and a subaddress,
the base address corresponds to the network address, and
the subaddress refers to a specific switching command or a device to be switched.

3. The method according to claim 1 wherein the network address is a call number or an IP address.

4. The method according to claim 1 wherein the network is a telephone network, a landline computer network, or a mobile wireless computer network.

5. The method according to claim 1 wherein the output command is sent as a remote-control signal using a signal transmitter.

6. The method according to claim 1 wherein one or more electrical supply lines are switched on or off by the output commands and are acted on by a predetermined or selectable voltage or current intensity.

7. The method according to one claim 1 wherein the receipt of the input commands and the signal conversion are carried out by a base station of a local network that is connected to a number of network components or network users in the local network via cable connections or wireless connections.

8. An apparatus for switching or controlling a number of functions by switching electrical supply lines or by remote-control signals wherein
the apparatus may be addressed using a network address via a network, and commands may be received via this network, and
the received commands may be converted by the apparatus to corresponding output commands for switching or control, or the apparatus is set up to convert the received commands to corresponding output commands for switching or control, and to transmit or send the generated output commands for switching or controlling the functions.

9. The apparatus according to claim 8, wherein the received commands are formed by a base address and a subaddress, wherein the base address corresponds to the network address, and the subaddress refers to a specific switching command or a device to be switched.

10. The apparatus according to claim 8 wherein the network address is a call number or an IP address.

11. The apparatus according to claim 8 wherein the network is a telephone network or a computer network, in particular a landline network or a mobile wireless network.

12. The apparatus according to claim 8 wherein a signal transmitter is provided, and the output command may be sent as a remote-control signal by the signal transmitter, or the signal transmitter is set up in such a way that the output command is sent in particular as an infrared signal.

13. The apparatus according to claim 8 wherein by means of the output commands one or more electrical supply lines may be switched on or off, or are switched on or off, and in particular electrical supply lines are acted on with a predetermined voltage or current intensity.

14. The apparatus according to claim 8 wherein the apparatus is a base station of a local network, in particular having cable connections or wireless connections to a number of network components or network users in the local network.

15. The apparatus according to claim 8 wherein within a private local network the apparatus is set up to communicate directly with network components or terminals, in particular via wireless connections.
